(19) United States
(12) Patent Application Publication
(10) Pub. No.: US 2005/0042504 A1
(43) Pub. Date: Feb. 24, 2005

(54) Li-ion secondary battery with double standard cells

(76) Inventor: Chih-Ju Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/644,838

(22) Filed: Aug. 21, 2003

(51) Int. Cl. H01M 10/04; H01M 10/48

(52) U.S. Cl. 429/159; 429/7; 429/92

(57) ABSTRACT

A Li-ion secondary battery with double standard cells is disclosed in the invention, which is to install two standard Li-ion cells inside a casing that has the same size as the size of the casing for two parallel-connected standard cells. In addition, a printed circuit board is also provided inside the casing, and four circuits are provided on the printed circuit board for different functions, including: a step-down circuit for stepping down the discharge voltage of the Li-ion cells, a charging circuit for charging the Li-ion cells in accordance with an adaptor inserted inside a charging slot, a protecting circuit for protecting the charge and discharge operations of the Li-ion cells, and a low-battery detecting circuit for detecting residual power of the Li-ion cells. Therefore, the invention can benefit from the advantages of being a standard battery and a Li-ion secondary battery.

### BACKGROUND OF THE INVENTION

1. Field of the Invention

The invention relates to a Li-ion secondary battery and, more particularly, to a Li-ion secondary battery with double standard cells.

2. Description of the Related Art

A battery is an apparatus that converts chemical energy into electrical energy. Because a battery has advantageous properties such as portability, diverse applicability, high energy density, non-noise emission, and non-gas emission, various batteries can be broadly applied in many fields.

A battery that is disposable is called first battery, whereas a battery that can be reused is called secondary battery. A secondary battery is also known as a rechargeable battery and rechargeable for more than two times. In fact, as long as a secondary battery can be recharged with direct current when the stored energy is used up, the battery can be repeatedly reused until it fails to do so.

A standard battery, such as a double A battery, has the advantage of being very popular and accessible. Therefore, standard batteries have been commonly used as power supply for many portable electronic products; digital cameras, for instance, often employ AA batteries as their power supply. In addition to being commonly used as a first battery, the standard battery can also be made into a secondary battery, but the Ni-CD battery and the Ni-MH battery are the only standard batteries that can qualify as secondary batteries. A Li-ion secondary battery, however, cannot be made into a standard battery due to the factor of incompatible voltage. Nevertheless, with lighter weight, lower self-discharge rate, larger capacity, less sensitivity to the ambient temperature, and longer reuse lifecycle, a Li-ion secondary battery is still superior to a Ni-MH battery in functionalities. Therefore, a lot of electronic products, such as mobile phones, are dedicated to the Li-ion secondary battery.

To cope with the aforementioned drawback of the Li-ion secondary battery, the invention makes the Li-ion secondary battery into a secondary battery with double standard cells that can benefit from being a standard battery and a secondary battery.

### SUMMARY OF THE INVENTION

The main and first object of the invention is to provide a Li-ion secondary battery with double standard cells that has the following advantages: light in weight, low self-discharge rate, large capacity, long reuse lifecycle, and less insensitivity to the ambient temperature; meanwhile, it can be as popular as a standard battery.

The second object of the invention is to provide a Li-ion secondary battery with double standard cells capable of protecting itself from overload or over-discharge.

The third object of the invention is to provide a Li-ion secondary battery with double standard cells capable of recharging the battery directly through an adaptor without using a charger.

To achieve the above-mentioned objects, the invention includes a casing, in which two standard Li-ion cells in standard size are provided and connected in parallel; and a printed circuit board, which is installed inside the casing and composed of the following circuits: first, a step-down circuit for stepping down the discharge voltage of the Li-ion cells; second, a charging circuit for charging the Li-ion cells; third, a protecting circuit for protecting charge and discharge operations of the Li-ion cells; and finally, a low-battery detecting circuit for detecting the residual power of the Li-ion cells.

The objects and technical contents of the invention will be better understood through the description of the following embodiment with reference to the drawings.

### BRIEF DESCRIPTION OF THE DRAWINGS

FIG. 1 is a schematic diagram showing an external view of the invention.

FIG. 2 is a schematic diagram showing the connecting relationship between the two standard Li-ion cells of the invention.

FIG. 3 is a block schematic diagram showing the structure of the invention.

### DETAILED DESCRIPTION OF THE PREFERRED EMBODIMENTS

The invention is to employ a casing to pack two Li-ion cells connected in parallel into a Li-ion secondary battery with double standard cells and to provide a printed circuit board inside the casing so that the circuits on the printed circuit board can control and protect the operation of the Li-ion cells and that the Li-ion secondary battery provided by the invention can benefit from the advantages of being a standard battery and a Li-ion secondary battery.

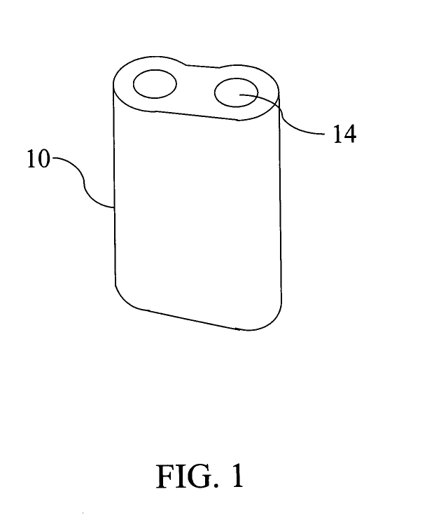

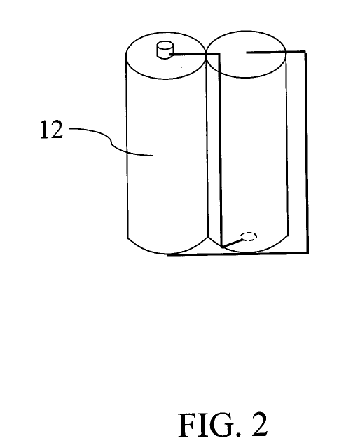

FIG. 1 is a schematic diagram showing an external view of the invention. As shown in FIG. 1, the Li-ion secondary battery with double standard cells includes a casing 10, and its size is designed similar to that of the two standard cells so that the casing 10 can be accommodated into the battery slot of an electronic product. Besides, two rechargeable standard Li-ion cells 12 connected in parallel are provided inside the casing 10, and the connecting relation between the two cells is shown in FIG. 2. The two Li-ion cells 12 are electrically connected in parallel, and the specification of the two Li-ion cells 12 is the same as that of the two standard cells; for example, an AA standard or AAA standard cell can do the job, but the double A size is used more often. In addition, the conducting points of the two Li-ion cells 12 are exposed outside the casing to be used as a connecting point 14 for external connection in order to provide electrical connection to the electronic product and supply power to it.

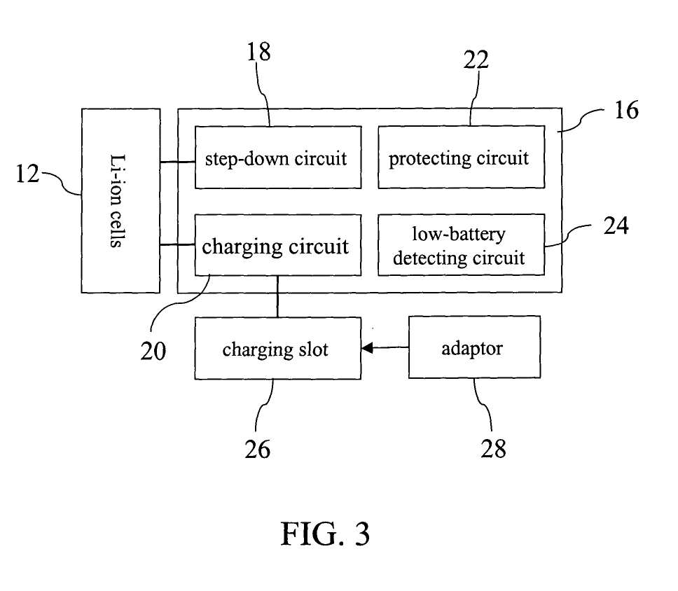

Also, a printed circuit board 16 is provided inside the casing 10 and electrically connected to the two Li-ion cells 12. Referring to FIG. 3, a step-down circuit 18, a charging circuit 20, a protecting circuit 22, and a low-battery detecting circuit 24 are all provided on the printed circuit board 16. The functions of the four circuits will be described below. First, the step-down circuit 18 is for stepping down the discharge voltage because the discharge voltage of the Li-ion cells 12, which always lies between 4.2 and 3.6 volts, is incompatible to the voltage of an electronic product. Therefore, the step-down circuit 18 is used to step down the discharge voltage of the Li-ion cells 12 to a level at about 3 volts in order to prevent the electronic product from damage caused by the excessive voltage. Second, the charging circuit 20 is for charging the Li-ion cells 12 when it is lacking power. Third, the protecting circuit 22 is for protecting the recharge and discharge operations of the Li-ion cells 12 so that the overcharge and over-discharge can be avoided. Fourth, the low-battery detecting circuit 24 is for detecting the power of the Li-ion cells 12; that is, when the low-battery detecting circuit 24 detects that the power inside the Li-ion cells 12 is running out, the step-down circuit 18 will lower the voltage to at about 2 volts so that the electronic product can sense the low voltage and then give a warning to the user for a battery recharge.

As to the recharge operation, first, the charging circuit 20 is connected to a charging slot 26 provided on the casing 10. Then, through the adaptor 28 that is inserted inside the charging slot 26, the charging circuit 20 can recharge the Li-ion cells 12 directly without employing any charger. Meanwhile, when executing the recharge operation, the protecting circuit 22 will protect the Li-ion cells 12 from overcharging during the operation.

In conclusion, the Li-ion secondary battery with double standard cells provided by the invention is to apply a specific circuit design so that the discharged voltage of the double standard cells can be compatible to the voltage of a general electronic product. In addition, the Li-ion secondary battery can benefit from its following properties: light in weight, low self-discharge rate, large capacity, long reuse lifecycle, and less insensitivity to the ambient temperature and, meanwhile, can be as popular as a standard battery and easy to be obtained.

The embodiment above is only intended to illustrate the invention; it does not, however, to limit the invention to the specific embodiment. Accordingly, various modifications and changes may be made without departing from the spirit and scope of the invention as described in the appended claims.

1. A Li-ion secondary battery with double standard cells, including:
a casing, having the same size as the size of the casing for double standard cells;
two standard Li-ion cells, connected in parallel and installed inside the casing; and
a printed circuit board, which is located inside the casing; also, a step-down circuit for stepping down the discharge voltage of the Li-ion cells, a charging circuit for charging the Li-ion cells, a protecting circuit for protecting the Li-ion cells, and a low-battery detecting circuit for detecting the power of the Li-ion cells are provided on the printed circuit board.

2. The Li-ion secondary battery with double standard cells as claimed in claim 1, wherein a charging slot is provided on the casing and connected to the charging circuit so that an adaptor inserted inside the charging slot can charge the Li-ion cells.

3. The Li-ion secondary battery with double standard cells as claimed in claim 1, wherein the standard cells are selected from either an AA standard cell or an AAA standard cell.

4. The Li-ion secondary battery with double standard cells as claimed in claim 1, wherein the discharge voltage of the Li-ion cells is between 3.6 and 4.2 volts, and the step-down circuit will step down the discharge voltage of the Li-ion cells to at about 3 volts.

5. The Li-ion secondary battery with double standard cells as claimed in claim 1, wherein when the low-battery detecting circuit detects that the power of the Li-ion cells is running out, the step-down circuit will switch the voltage to a low voltage in order that the electronic product can sense the low voltage.

6. The Li-ion secondary battery with double standard cells as claimed in claim 5, wherein the step-down circuit will lower the voltage to a 2-volt low voltage.
